(19) United States
(12) Patent Application Publication
(10) Pub. No.: US 2008/0237220 A1
(43) Pub. Date: Oct. 2, 2008

(54) Device For Protection Against Frost and Uses Thereof

(75) Inventor: Gerard Sekrane, Agen (FR)

Correspondence Address: BROWDY AND NEIMARK, P.L.L.C.;624 NINTH STREET, NW, SUITE 300, WASHINGTON, DC, 20001-5303, US

(73) Assignee: Gerard SEKRANE, Agen (FR)

(21) Appl. No.: 11/996,449

(22) PCT Filed: Jul. 6, 2006
(86) PCT No.: PCT/FR2006/001665

§ 371 Date: Jun. 2, 2008

(30) Foreign Application Priority Data
Jul. 22, 2005 (FR) 05 07862

(51) Int. Cl. H05B 3/34

(52) U.S. Cl. 219/528

(57) ABSTRACT

The invention concerns a device for protecting elements against frost comprising an adaptable multilayer band comprising at least: means for fixing on the elements, at least one protective surface layer (1) against bad weather conditions on each side of the band and between said two surface layers: a) a heating layer (3) including heating means, said heating means being distributed into modules electrically powered independently of one another, b) a structural layer (2) to provide mechanical resistance to prevent the band from being pulled off or torn.

The present invention relates to a frost protection device. It is more particularly but not exclusively applied to protecting plantations such as vines and fruit-trees notably during blossoming and at the beginning of the fruit-bearing period or further to protecting plants on balconies or plants in greenhouses.

It also applies to protecting high-voltage lines, fluid conduits, whether buried or not.

It is also useful for making materials such as tent fabrics, or for making claddings and/or urban furnitures such as roofings, pavements, pedestrian crossings.

Generally, spring is an important and sensitive period for the quality and amount of the harvests of the coming year.

Indeed, at this time, young shoots such as fruit-bearing buds are formed and are rich in water. Frost may then cause their bursting, as water in its frozen form has a larger volume than water as a liquid.

Moreover, certain market garden cultivations or cultivations located in regions having a colder climate such as in mountains, may also suffer from winter frost.

In order to avoid frost on plantations, several solutions exist:

Certain solutions such as mulching soils, are very simple to apply but provide uncertain or even detrimental results. In particular, mulching the soil prevents heat exchanges and promotes frost on the aerial portions of the plants.

Other solutions such as setting up points heated with heating oil, a blower by helicopter, water spraying are more complex to apply both on the level of the incurred costs (up to several hundreds of thousands of euros per hour and per hectare (2.47 acres)) and of the required labor.

Furthermore, these solutions have a very low energy yield, i.e. large energy consumptions only provide a small effect at the specific places to be treated, i.e. the flowers and young shoots, much of this energy being dispersed beforehand.

The object of the invention is to solve these drawbacks by means of a solution having good energy yield for a reduced operating cost, for example of the order of a few euros per hour and per hectare.

For this purpose, it provides a device for protecting elements against frost comprising an adaptable multilayer ribbon including at least:
means for attaching it onto the elements,
at least one surface layer for protection against bad weather (water, sun, wind . . . ) on either side of the ribbon and between both of these surface layers:
   a heating layer comprising heating means, these heating means being distributed into modules powered electrically independently of each other,
   a structural layer in order to provide mechanical strength of the ribbon against pulling and tearing.

Said elements may be plantations, high-voltage lines, conduits for fluids such as water, flexible materials such as a tent fabric, claddings such as roofings, urban furniture such as pavements, pedestrian crossings.

According to one alternative, it proposes a device for protecting plantations against frost comprising an adaptable multilayer ribbon including at least:
means for attaching it onto the plantations,
at least one surface layer for protection against bad weather (water, sun, wind . . . ) on either side of the ribbon and between both of these surface layers:
   a heating layer comprising heating means, these heating means being distributed in modules powered electrically independently of each other,
   a structural layer in order to provide mechanical strength of the ribbon against pulling and tearing.

Said means for attachment onto the elements may consist in borings such as perforations or notches placed between the independent modules.

Said boring may be regular, for example a multiple of the distance between two plants.

The tightness of the ribbon may be obtained by welding the side edges of the surface layers together or by using a thermoformable sheath.

UV resistance of the surface layers may be achieved by absorption and/next inhibition of free radicals.

The heating means may be radiating means in order to optimize the use of the released heat on the areas to be protected.

According to one alternative, the ribbon may further comprise an insulating and/or reflecting layer in order to further increase control on the direction of heat flow on the areas to be protected.

The heating means may comprise heating (resistive) elements positioned in series or in parallel.

In the case of a mounting in series, the ribbon may only comprise a single track in which purely conducting sections alternate with resistive heating elements, the supply voltage being then applied to both ends of the track.

In the case of a mounting in parallel, the ribbon will necessarily comprise two parallel conducting tracks between which resistive heating elements are connected. The voltage is then applied on both conducting tracks at any location along the strip.

Advantageously, accidental opening, altering a heating component will not have any repercussion on the power supply of the other heating components.

The modules may comprise optionally:
a heating element.
at least two heating elements mounted in series,
at least two heating elements mounted in parallel,
a combination of the preceding options.

Said heating means may comprise flexible heating films.

Said flexible heating films may comprise one or more metal ribbons in mono-metal placed between two polymer layers for example in polyester polyethylene, welded together.

Said modules may be supplied with low voltage.

Said modules may be powered from the conventional electrical mains network or from means such as accumulators, wind turbines.

The power supply means are designed in order to ensure that the whole of the ribbon operates even in the case of malfunction of a heating module. Actually, each module is powered by a ground and a phase independently.

The structural layer may include fiber reinforcement elements.

The device may further be regulated by means of temperature probes, the measurements of which may trigger or switch off the device with very high reactivity and without requiring any human intervention.

The ribbon may be packaged as reels which are unwound in the axis of the plantations.

Ribbons of different widths and/or lengths may be connected together by means of sealed connections.

The ribbon may be positioned so as to be inserted between the wind and the areas to be protected.

Indeed, the air flow will exert a pressure on one face of the ribbon in contact with which it will warm up before being deflected and then flowing to the rear of the ribbon in a turbulent flow which will be mixed with the heated air in contact with the other face of the ribbon while generating a heated area protected from the wind. With this protection from the wind, it is possible to reduce the heat exchanges and thereby obtain a larger heated area while spending less energy for a same temperature level.

If the ribbon is located in a plane perpendicular to the ground, then the protected area will also extend substantially perpendicularly to the ground.

If the ribbon is located in a plane forming an angle different from 90° while forming an obstacle to the wind with the ground, then the area will be protected substantially according to the same angle.

The invention includes many other advantages notably:
storage is greatly facilitated.
great rapidity and simplicity in its application,
a large heating surface area,
optimized use of the produced heat by the orientation of the heat flow and the positioning of the device in immediate proximity to the areas to be heated,
by using independent modules, it is possible to use a required and sufficient length of ribbon and to minimize the importance and impact of malfunction of a heating module.

Embodiments of the invention will be described hereafter, as non-limiting examples, with reference to the appended drawings wherein:

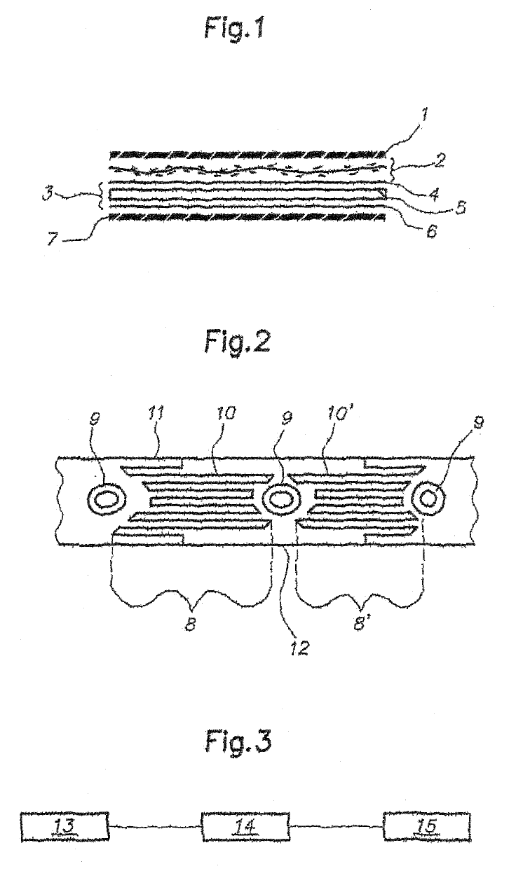

FIG. 1 is an exploded sectional illustration of a device according to the invention:

FIG. 2 is a top view illustration of a heating layer of FIG. 1;

FIG. 3 is an illustration of a simplified electric circuit for applying a device according to the invention.

The example of FIG. 1 illustrates a multilayer ribbon R according to the invention which may be assembled by heat-melting including:
a surface layer 1 for protection against bad weather (water, sun, wind . . . ) for example in polyester or polyvinyl fluoride (TEDLAR (registered trademark)) or polyimide (KAPTON (registered trademark)),
a heat-reactable structural layer 2 including coated fiber reinforcement elements such as a layer reinforced with glass mat, roller-pressed with a polyester resin of the GIRACOAT GP 3027 and/or SMC HP type,
a heating layer 3 comprising:
   a heat-activatable separation film 4 for example in polyester/polyvinyl fluoride, for allowing hot assembly,
   a layer 5 comprising heating modules mounted in parallel, each including a radiating track comprising a metal ribbon in mono-metal,
   a heat activatable separation film 6; for example in polyester/polyvinyl fluoride in order to allow hot assembly,
a surface layer 7 for protection against bad weather (water, sun, wind . . . ) for example in polyester or in polyvinyl fluoride (TEDLAR (registered trademark)) or in polyimide (KAPTON (registered trademark)).

It should be noted that a layer consisting of a confined air mat insulator and of a reflector such as an aluminium foil may be inserted between the structural layer and the separation film.

Further, electric power supply means of each module are provided but not shown in this FIG. 1.

The power supply is provided with a voltage of 220 volts or 24 volts depending on the European power supply connection standards.

Different sources of electricity may be used such as accumulators, wind turbines, . . . .

It should be noted that temperature probes may be associated with the device in order to allow the starting of said device without human intervention, if need be.

Two modules 8, 8′ and their electric power supply means are clearly visible in the illustration of the heating layer 3 of FIG. 2.

Each module is located between two attachment perforations 9 and comprises a radiating track 10, 10′ including a metal ribbon in mono-metal.

Said modules are mounted in parallel: the radiating tracks 10, 10′ are each connected at one of their ends to a phase cable 11 located along a side edge of the ribbon and at the other end to a ground cable 12 located along the other side edge of the ribbon, both of these cables being placed between both separation films 4, 6 welded together.

These cables are sealed standardized cords.

Said radiating tracks 10, 10′ are positioned as a serpentine so as to produce homogenous distribution of heat.

Thus, failure of track 11 has no effect on the operation of the preceding track, 11, and of the following track (not shown in the figure).

The diagram of FIG. 3 comprises a device according to the invention (block 13) connected to a power supply (block 14) and temperature probes (block 15) also connected to the power supply (block 14).

The invention is not limited to the examples described earlier.

For example, the radiating tracks may adopt any adequate configurations in order to obtain an optimum effect relatively to the contemplated use.

The invention may also be used without any modification for protecting high voltage lines, fluid conduits, whether buried or not.

It may also be incorporated in flexible materials for notably making tent fabrics so as to be helpful during use in mountains or for meeting a need of provisional shelters notably during natural catastrophes.

It may also be incorporated or laid on claddings such as roofings and/or urban furniture such as pavements, pedestrian crossings for preventing the fall of pedestrians.

Indeed, the use of a material such as KEVLAR (registered trade mark) as a protective layer provides the invention with sufficient strength for supporting the weight of pedestrians for example.

1. A device for protecting elements against frost comprising:
an adaptable multilayer ribbon, means for attaching it on the elements, at least one surface layer for protection against bad weather on either side of the ribbon and between both of these surface layers, a heating layer comprising heating means, these heating means being distributed as modules electrically powered independently of each other, and a structural layer for providing a mechanical strength of the ribbon to pulling and tearing.

2. The device according to claim 1, wherein said elements are selected from a group comprising plantations, high voltage lines, conduits for fluids, flexible materials, claddings, urban furniture.

3. The device according to claim 1, wherein said attachment means on the elements comprises borings (9).

4. The device according to claim 1, wherein the ribbon R has a seal which is obtained by welding the side edges of the surface layers (1, 7) to each other or by using a thermoformable sheath.

5. The device according to claim 1, wherein said heating means (10, 10′) are radiating means.

6. The device according to claim 1, wherein said heating means comprise heating elements (10, 10′) arranged in series or in parallel.

7. The device according to claim 1, wherein said heating means comprise flexible heating films.

8. The device according to claim 1, wherein said flexible heating films comprise one or more metal ribbons in mono-metal (10, 10′) placed between two polymer layers (4, 6) welded together.

9. The device according to claim 1, wherein said modules optionally comprise:
a heating element,
several heating elements mounted in series,
at least one heating element mounted in parallel,
a combination of the preceding options.

10. The device according to claim 1, wherein said structural layer (2) comprises fiber reinforcement elements.

11. The device according to claim 1, further comprising temperature probes for triggering or switching off said device.

12. The device according to claim 1, further comprising a reflecting layer for optimizing the direction of heat flow depending on a contemplated application.

13. The device according to claim 1, which is positioned so as to be inserted between the wind and the areas to be protected.

14. Device for protecting plantations against frost which comprises an adaptable multilayer ribbon, means for attaching it on the elements, at least one surface layer for protection against bad weather on either side of the ribbon and between both of these surface layers, a heating layer comprising heating means, these heating means being distributed as modules electrically powered independently of each other, and a structural layer for providing a mechanical strength of the ribbon to pulling and tearing.

15. Device for protecting high voltage lines and/or fluid conduits, whether buried or not, against frost, said device comprising an adaptable multilayer ribbon, means for attaching it on the elements, at least one surface layer for protection against bad weather on either side of the ribbon and between both of these surface layers, a heating layer comprising heating means, these heating means being distributed as modules electrically powered independently of each other, and a structural layer for providing a mechanical strength of the ribbon to pulling and tearing.

16. Flexible materials incorporating a device which comprises an adaptable multilayer ribbon, means for attaching it on the elements, at least one surface layer for protection against bad weather on either side of the ribbon and between both of these surface layers, a heating layer comprising heating means, these heating means being distributed as modules electrically powered independently of each other, and a structural layer for providing a mechanical strength of the ribbon to pulling and tearing.

17. Claddings and/or urban furniture provided with a device comprising an adaptable multilayer ribbon, means for attaching it on the elements, at least one surface layer for protection against bad weather on either side of the ribbon and between both of these surface layers, a heating layer comprising heating means, these heating means being distributed as modules electrically powered independently of each other, and a structural layer for providing a mechanical strength of the ribbon to pulling and tearing.
